(19) United States
(12) Patent Application Publication
(10) Pub. No.: US 2009/0174229 A1
(43) Pub. Date: Jul. 9, 2009

(54) Stiffened Multi-Part Sunroof

(75) Inventors: Tony Ordonio, Dublin, OH (US); Shawn Tarr, Dublin, OH (US); Thomas Croyle, Milford Center, OH (US); Carmen Crowley, Powell, OH (US)

Correspondence Address: BROUSE MCDOWELL LPA, 388 SOUTH MAIN STREET, SUITE 500, AKRON, OH, 44311, US

(73) Assignee: HONDA MOTOR CO. LTD, Tokyo (JP)

(21) Appl. No.: 11/968,842

(22) Filed: Jan. 3, 2008

(51) Int. Cl. B60J 7/043

(52) U.S. Cl. 296/216.06

(57) ABSTRACT

The present invention is generally directed to vehicle roof frames. Some embodiments comprise frames fabricated from a plurality of parts rather than a single part. In such embodiments, one or more of the plurality of parts can comprise a material thickness and/or composition that differs from that of one or more other parts. Accordingly, strength can be added to selected parts without increasing the weight and/or cost of every part. Some embodiments also include sunroof frames.

### CROSS-REFERENCE TO RELATED APPLICATIONS

This application claims the benefit of U.S. Provisional Application No. 60/878,359 filed on Dec. 31, 2006.

### BACKGROUND OF THE INVENTION

1. Field of the Invention

The present invention is directed generally to motor vehicle roof frames. Some embodiments relate to means for stiffening sunroofs.

2. Description of Related Art

The frame of a motor vehicle includes structural members to which all other features of the motor vehicle are coupled. The frame forms a rigid body that establishes the general shape of the motor vehicle and offers protection to the occupants of the motor vehicle during operation. One structural member of the frame is what is commonly referred to as the A-pillar. The A-pillar of the frame is the front-most pillar of the passenger compartment that typically establishes a lateral side of the front windshield. Since the A-pillar plays an important role in protecting occupants of the vehicle in the event of a roll over incident, the overall size of the A-pillar has been increased to maximize that protection. Increasing the size of the A-pillar, however, tends to add weight to the motor vehicle, thereby hampering the performance of that vehicle.

Another structural member of the frame is commonly referred to as the B-pillar. The B-pillar of the frame is typically the structural member immediately following the A-pillar progressing toward the rear of the vehicle. The B-pillar offers the occupants of the motor vehicle protection in the event of a side impact incident. A strong B-pillar is desirable to minimize the side impact cabin intrusion caused by such an incident. But as with the A-pillar, increasing the strength of the B-pillar typically requires increasing the overall size of the B-pillar leading to excess weight on the motor vehicle.

The A-pillar and B-pillar are provided to each lateral side of the motor vehicle. A roof frame portion extends between the A-pillars and B-pillars of the motor vehicle, thereby providing support to uppermost portions of those pillars while the vehicle is resting on its wheels. To limit the overall weight of a motor vehicle provided with robust A-pillars and B-pillars, a balance must be struck between the weight of the roof frame portion and the structural support to be provided to the uppermost portions of the A-pillar and B-pillars.

The roof portion of a motor vehicle is typically made as a monolithic unit from a suitably rigid material such as a metal. Conventional stamping processes require a uniform thickness over an entire part. Therefore, according to conventional methods, if the material thickness needed to be greater at one location of the roof than at other locations, the thickness of the entire part needed to be increased. Increasing the overall thickness of the monolith as a whole provides enhanced structural support to the A-pillars and B-pillars of the vehicle, but may excessively increase the vehicle's weight.

Other attempts to strike the delicate balance between weight and structural support offered by the roof portion have focused on adding supplemental reinforcements to the monolithically-stamped roof portion. However, the addition of the supplemental reinforcements during assembly of the vehicle adds to assembly cost, and increases the overall weight of the vehicle.

Accordingly, there is a need in the art for a roof frame portion for supporting an adjustable roof panel and providing adequate structural support to the laterally-disposed A- and B-pillars. Such a frame includes suitably-sized components for establishing the proper structural support while minimizing weight. The frame can also optionally minimize sunroof booming experienced by occupants during operation of the motor vehicle.

### BRIEF SUMMARY OF THE INVENTION

According to one embodiment a vehicle roof frame comprises, a front transverse member adapted to be positioned adjacent to a fore section of a motor vehicle cabin and oriented perpendicular to a longitudinal axis of the motor vehicle; a rear transverse member adapted to be positioned adjacent to an alt section of the motor vehicle cabin and oriented perpendicular to the longitudinal axis of the motor vehicle; a first side rail extending from the front transverse member to the rear transverse member, the first side rail being attached to the front and rear transverse members, and running in a generally parallel direction relative to the longitudinal axis; a second side rail extending from the front transverse member to the rear transverse member, the second side rail being attached to the front and rear transverse members, and running in a generally parallel direction relative to the longitudinal axis; and a sunroof frame attached to the vehicle roof frame, the sunroof frame being adapted to receive a sunroof panel; wherein, at least one of the components including the front transverse member, the rear transverse member, the first side rail and the second side rail, or the sunroof frame has a thickness that differs from that of the other components.

According to another embodiment a vehicle roof frame comprises: a front transverse portion adapted oriented perpendicular to a longitudinal axis of the motor vehicle; a rear transverse portion oriented perpendicular to the longitudinal axis of the motor vehicle; a first side rail portion extending from the front transverse member to the rear transverse member, the first side rail portion running in a generally parallel direction relative to the longitudinal axis; a second side rail portion extending from the front transverse member to the rear transverse member, the second side rail portion running in a generally parallel direction relative to the longitudinal axis; and a portion of the vehicle roof frame defining a sunroof frame portion, the sunroof frame being adapted to receive a sunroof panel; wherein, at least one of the roof frame portions including the front transverse portion, the rear transverse portion, the first side rail portion, the second side rail portion, or the sunroof frame portion has a thickness that differs from that of the other portions.

### BRIEF DESCRIPTION OF THE DRAWINGS

The invention may take physical form in certain parts and arrangement of parts, embodiments of which will be described in detail in this specification and illustrated in the accompanying drawings which form a part hereof, and wherein:

FIG. 1 is a perspective view of a portion of a motor vehicle frame including a sunroof and various related components.

FIG. 2 is a perspective view of a portion of a motor vehicle frame including a sunroof and various related components.

FIG. 3 is a plan view of a motor vehicle roof frame including a sunroof.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items.

As used herein, the term “thickness” includes a thickness of metal sheet stock used for fabrication of metal parts, e.g. by stamping or other methods. Although parts fabricated therefrom can optionally include one or more contours, these contours are typically stamped such that the thickness of a material does not substantially change from the thickness of the metal sheet stock material.

Some embodiments relate to a sunroof stiffener. According to some embodiments, a sunroof stiffener comprises a plurality of component parts. In some embodiments, the component parts can have differing material thicknesses. Accordingly, if added strength is needed in one part, the thickness thereof can be increased without increasing the thickness of each of the other components. According to some embodiments, the component parts can be made by any of a variety of known processes including, without limitation, molding, stamping, forging, and the like. Suitable materials can include any of a variety of suitably durable metals and alloys including, without limitation, steel, ferrous alloys, and aluminum and alloys thereof. A variety of means for assembling the parts can be suitable, including without limitation, welding, brazing, and fastening.

In some embodiments, a front transverse member can be attached to a leading edge of each of a pair of side rails. Likewise, a rear transverse member can also be attached to a leading edge of each of the pair of side rails. Further, any number of intermediate transverse members between the front and rear transverse members can also be included, and attached to the side rails. Some embodiments include an aperture adapted to receive a transparent pane comprising a sunroof.

In some embodiments the thickness of one or more intermediate transverse members can be increased. Increasing the thickness of such members can enhance safety, for example, by mitigating or eliminating damage to the cabin in the event of a roll-over or side impact. In some embodiments increased thickness of some parts may be useful for mitigating or eliminating a phenomenon known as sunroof booming, wherein excessive noise is generated by air passing over components of a sunroof at high velocity. Accordingly, in some embodiments safety and/or sunroof booming can be mitigated or eliminated without increasing the thickness of the entire embodiment, but rather increasing the thickness only of selected components.

In some embodiments the strength of one or more intermediate transverse members can be adjusted by selecting one of a variety of acceptable materials for fabricating them. For example, if more strength is required then a higher grade of steel may be selected such as 590R, which has a tensile strength of about 590 MPa. Alternatively, if less strength is required then a lower grade of steel may be selected such as 270C, which has a tensile strength of about 270 MPa. One of skill in the art will recognize that the present invention can comprise any of a variety of materials and grades thereof. Furthermore, one of skill in the art will recognize that the strength of intermediate transverse members can be adjusted by manipulating material choice or part thickness, either alone or in combination.

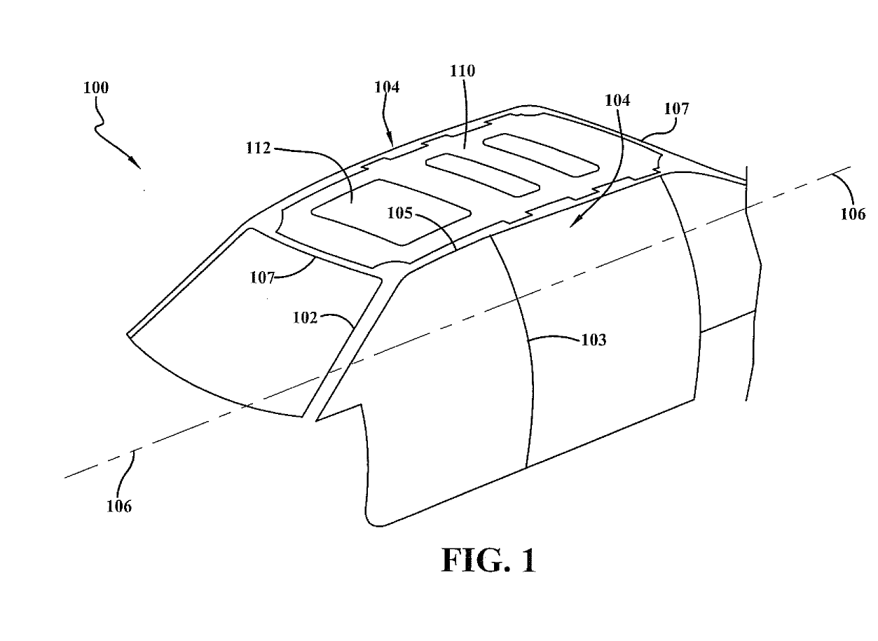

FIG. 1 schematically depicts an embodiment 100 comprising a frame of a motor vehicle. The frame provides structural integrity to the motor vehicle. The frame also provides an internal skeleton to which the other components of the motor vehicle are secured. As shown in FIG. 1, the frame includes an A-pillar 102 and a B-pillar 103 on each lateral side 104 of the motor vehicle. A roof support 105 extends in a generally parallel direction relative to a longitudinal axis 106 of the motor vehicle between the A-pillar 102 and the B-pillar 103 and further rearward to define an outline of a roof of the motor vehicle. A transverse member 107 can extend in a generally perpendicular direction relative to the longitudinal axis 106 between the A-pillar 102 provided to each lateral side 104 of the motor vehicle. Another transverse member 107 can optionally similarly be disposed between the B-pillars 103, an optionally further rearward on the motor vehicle frame. Together, the roof supports 105 and the transverse members 107 define the roof portion 110 of the motor vehicle. The roof portion 110 can also include an opening such as a sunroof 112.

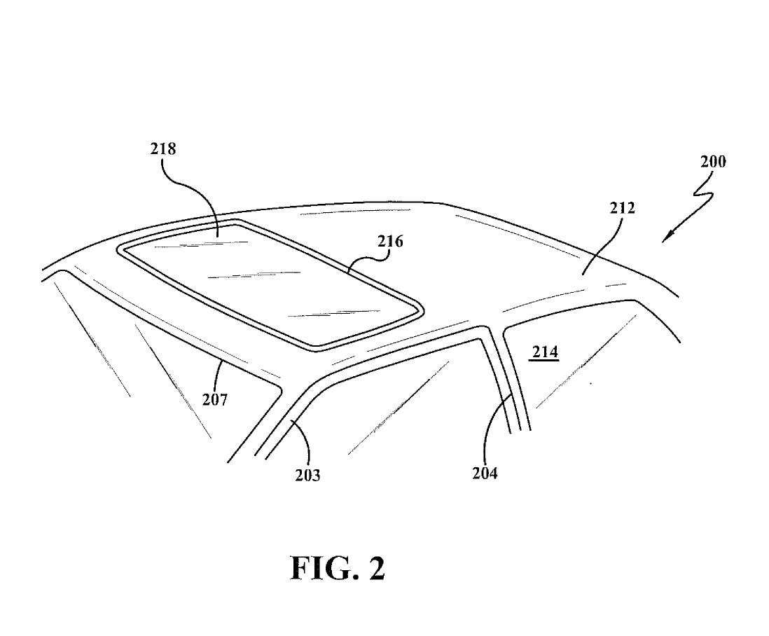

With reference to FIG. 2, an embodiment 200 includes a roof panel 212 supported by a plurality of vertical supports including A-pillars 203, and B-pillars 204. The roof panel 212 is also supported by a plurality of transverse support members 207. The roof panel 212 encloses a portion of a passenger cabin 214 of the motor vehicle. The embodiment also defines a sunroof frame 216 for receiving a substantially transparent roof panel 218, also referred to herein as a sunroof. The sunroof 218 can optionally be adjustable, for example, to at least partially retract in a rearward direction relative to the roof panel 212. Some embodiments can include a sunroof 218 that can be fully retracted to completely expose outer periphery 216, while other embodiments can allow only partial retraction of the sunroof 218. In still other embodiments, the sunroof 218 can be retracted in a rearward direction, sliding over the roof panel 712, or retracted in a rearward direction, sliding within a space defined between the roof panel 212 and an interior of the motor vehicle's cabin 214.

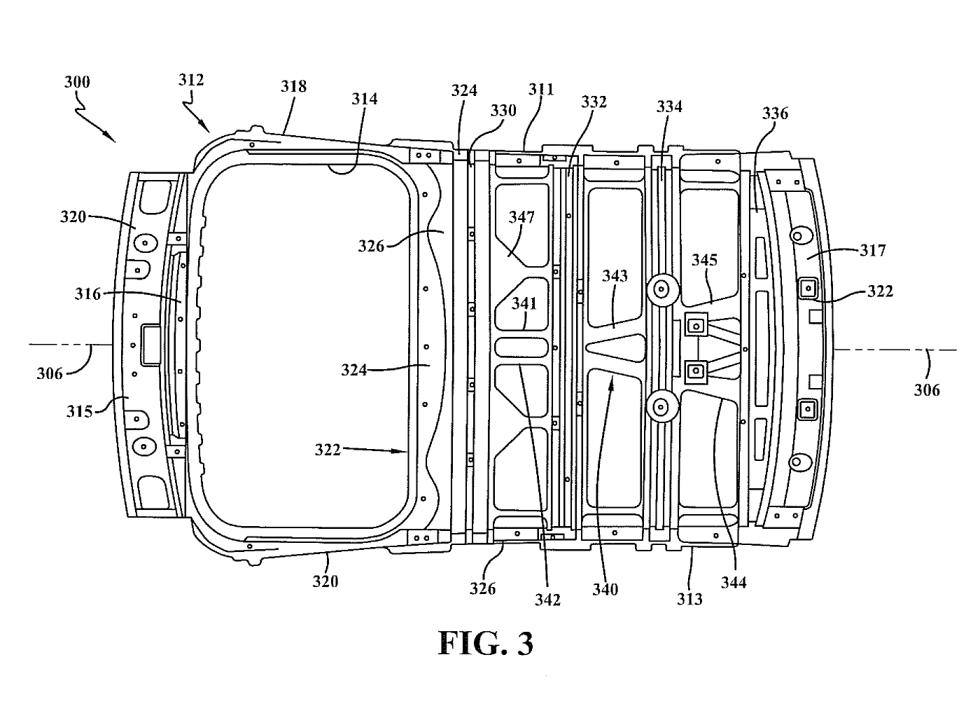

FIG. 3 shows a plan view of an embodiment 300 comprising a roof frame. As shown, the roof frame includes a front transverse member 320, a rear transverse member 322 and two laterally spaced side rails 324, 326 extending between the front and rear transverse members 320, 322. One or more intermediate transverse members 330 could optionally extend between the side rails 324, 326 at locations along the longitudinal axis 306 running between the front and rear transverse members 320, 322.

As shown in FIG. 3, each of the front, rear and intermediate transverse members 320, 322, 330 are separate components of the roof frame 300. Each of these separate components can be assembled and coupled together to collectively form the roof frame 300. Suitable methods for coupling each of the components together include, without limitation, welding, mechanical fasteners, and the like.

Some embodiments can include fabricating the various members, e.g. front and rear transverse members 320, 322 and the side rails 324, 326 by stamping a suitably durable metallic material, and assembling the members to form a roof. In some embodiments, at least one of the front transverse member 320, rear transverse member 322, and the side rails 324, 326 has a different material thickness than at least one of the other members. Thus, the desired structural strength and rigidity of the roof frame 300 can be established while at the same time minimizing weight by fabricating each component to a suitable material thickness.

According to one embodiment, the rear transverse member 322 can be stamped from a metallic sheet having a thickness T. Thickness T is suitable to provide the rear transverse member 322 with a desired structural strength between lateral sides 324 and 326 of the motor vehicle. Strengthening transverse member 322 tends to lessen damage sustained by the occupant's cabin in the event of a rollover. Thus, according to some embodiments the thickness of the rear transverse member 322 can be greater than that of the front transverse member 320. Therefore, the front transverse member 320 can be stamped from a metallic sheet having a thickness less than thickness T. For instance, the front transverse member 320 can optionally be stamped from a metal sheet having a thickness of about 0.7 T.

Stamping the front transverse member 320 from a metallic sheet having a thickness that is less than that of the rear transverse member 322 provides the roof frame 300 with an appropriate level of structural strength while mitigating weight. One of skill in the art will appreciate that the various component parts can be stamped from metal sheets having any of a wide variety of suitable thicknesses. Alternate embodiments include a rear transverse member 322 stamped from a metallic sheet having a thickness T that is less than that of the front transverse member 320. Any combination of thicknesses of the front and rear transverse members 320, 322 or other components can be provided to give the roof frame 300 the desired level of structural strength while mitigating weight.

In some embodiments, each of the side rails 324, 326 can independently be stamped from a metal sheet having a thickness selected to achieve a desired structural strength while mitigating weight. For example, each of the side rails 324, 326 can be stamped from a metal sheet having a thickness of 0.8 T, or 80% of the thickness T of the metal sheet from which the rear transverse member 322 is stamped. One of skill in the art will appreciate that a wide range of thicknesses can be appropriate depending on the specific application. Both of the side rails 324, 326 can be stamped from metallic sheets having the same thickness, a single metallic sheet having a single thickness, or from separate metallic sheets each having a different thickness.

Some embodiments include fabricating parts from one or more metal sheets having a minimal thickness required to provide an acceptable level of structural strength, while mitigating weight. The specific thickness, or combination of thicknesses, that it appropriate varies from one application to another. However, in some embodiments at least one of the front cross member 320, rear cross member 322, side rail 324 and side rail 326 has a thickness that is different from one or more of the other component parts.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. A vehicle roof frame, comprising:
a front transverse member adapted to be positioned adjacent to a fore section of a motor vehicle cabin and oriented perpendicular to a longitudinal axis of the motor vehicle;
a rear transverse member adapted to be positioned adjacent to an aft section of the motor vehicle cabin and oriented perpendicular to the longitudinal axis of the motor vehicle;
at least one intermediate transverse member disposed between the front transverse member and the rear transverse member and oriented perpendicular to the longitudinal axis of the motor vehicle;
a first side rail extending from the front transverse member to the rear transverse member, the first side rail being attached to the front and rear transverse members, and running in a generally parallel direction relative to the longitudinal axis;
a second side rail extending from the front transverse member to the rear transverse member, the second side rail being attached to the front and rear transverse members, and running in a generally parallel direction relative to the longitudinal axis; and
a sunroof frame attached to the vehicle roof frame, the sunroof frame being adapted to receive a sunroof panel;
wherein, at least one of the components including the front transverse member, the rear transverse member, the first side rail and the second side rail, or the sunroof frame has a thickness that differs from that of the other components.

2. The frame of claim 1, wherein one or more of the first and second side rails are attached to one or more of the front and rear transverse members by a means selected from the group consisting of fasteners, welding, and brazing.

3. The frame of claim 1, wherein at least one component part comprises a material selected from the group consisting of ferrous alloys, steel, aluminum, and aluminum alloys.

4. The frame of claim 3, wherein the at least one component part comprises a steel having a tensile strength from about 270 to about 590 MPa.

5. The frame of claim 1, wherein at least one component part of the roof frame is from about 1% to about 10,000% of the thickness of another component part of the roof frame.

6. A vehicle roof frame, comprising:
a front transverse portion adapted oriented perpendicular to a longitudinal axis of the motor vehicle:
a rear transverse portion oriented perpendicular to the longitudinal axis of the motor vehicle;
at least one intermediate transverse portion oriented perpendicular to the longitudinal axis of the motor vehicle;
a first side rail portion extending from the front transverse member to the rear transverse member, the first side rail portion running in a generally parallel direction relative to the longitudinal axis;
a second side rail portion extending from the front transverse member to the rear transverse member, the second side rail portion running in a generally parallel direction relative to the longitudinal axis; and
a portion of the vehicle roof frame defining a sunroof frame portion, the sunroof frame being adapted to receive a sunroof panel;
wherein, at least one of the roof frame portions including the front transverse portion, the rear transverse portion, the first side rail portion, the second side rail portion, or the sunroof frame portion has a thickness that differs from that of the other portions.

7. The vehicle roof frame of claim 6 wherein at least two of the portions are portions of a single part.

8. The vehicle roof frame of claim 6 wherein at least two of the portions comprise separate parts that are assembled to form the roof frame.

9. The vehicle roof frame of claim 8, wherein the at least two parts are attached by a means selected from the group consisting of fasteners, welding, and brazing.

10. The vehicle roof frame of claim 6, wherein each portion comprises a material independently selected from the group consisting of ferrous alloys, steel, aluminum, and aluminum alloys.

11. The frame of claim 10, wherein the at least one component part comprises a steel having a tensile strength from about 270 to about 590 MPa.

12. The vehicle roof frame of claim 7, wherein at least one part is from about 1% to about 10,000% of the thickness of another part.
